(19) United States
(12) Patent Application Publication
(10) Pub. No.: US 2013/0094809 A1
(43) Pub. Date: Apr. 18, 2013

(54) OPTICAL FIBRE COUPLER

(71) Applicants: Iain Botheroyd, Warwickshire (GB); Glyn Edwards, Warwickshire (GB); Steve Keen, Warwickshire (GB)

(72) Inventors: Iain Botheroyd, Warwickshire (GB); Glyn Edwards, Warwickshire (GB); Steve Keen, Warwickshire (GB)

(73) Assignee: GSI Group Limited, Warwickshire (GB)

(21) Appl. No.: 13/642,426

(22) PCT Filed: Mar. 25, 2011
(86) PCT No.: PCT/GB11/50615

§ 371 Date: Jan. 2, 2013

(30) Foreign Application Priority Data
Apr. 30, 2010 (GB) GB1007253.6

(51) Int. Cl. G02B 6/26

(52) U.S. Cl. CPC G02B 6/26
USPC 385/39; 29/428

(57) ABSTRACT

An optical assembly comprising a plurality of inputs comprising optical fibres which have a non-circular core cross-section, the fibres having a proximal end for receiving light from a respective diode emitter and a distal end, the fibres being combined at their distal ends and joined to a single output fibre which has a circular core cross-section, whereby in use light from a plurality of diode emitters is combined and output through the single output fibre.

This invention relates to optical apparatus. In particular, it relates to a combiner for combining the output of a plurality of emitter diodes such as laser diodes into a single output.

High power diode laser manufacturers commonly use diode laser bars as a primary source of laser power and free-space micro-optical methods to combine many individual laser emitters suitable for direct use or for launch into a beam delivery fibre. However, this involves the use of many precision aligned components, resulting in high complexity and cost.

Fibre-coupling of the single-emitters and subsequent fibre-combining is an attractive approach as it simplifies the optical arrangement required. However, most schemes use optical fibres with a circular core cross-section and hence introduce a significant loss of brightness—typically this involves 30 times brightness reduction.

One solution to this problem is to use a fibre with a rectangular core cross-section, as this geometry better matches the asymmetric output from a single-emitter laser diode. Here the brightness loss is much reduced, typically to a factor of 10 times.

For many applications it is advantageous to combine the output from numerous single-emitter fibre-coupled laser diodes into a single large-diameter output fibre. This output fibre is often required to have a circular cross-section. The combination of numerous fibre-coupled single-emitters may involve more than one fibre-combining stage. One disadvantage of these fibre-combining schemes is that at each combining stage, there is a significant loss of brightness.

This loss of brightness is due to the mismatch between the combined cross-sectional area of the cores of the input fibres and the cross-sectional area of the core of the output fibre.

The present invention arose in an attempt to provide an improved system which better conserves the brightness of combined fibre-coupled single emitter laser diodes, particularly for direct diode systems and fibre lasers.

More specifically, the present invention describes fibre-combining schemes which combine more than one input fibre with a rectangular core cross-section into a single output fibre with a circular core cross-section.

According to the present invention in a first aspect there is provided an optical combiner comprising a plurality of input optical fibres which have a non-circular cross-section, the fibres having a proximal end for receiving light from a respective diode emitter and a distal end, the fibres being combined at their distal ends and joined to a single circular output fibre, whereby in use light from a plurality of diode emitters is combined and output through the single output fibre.

The input fibres are preferably rectangular or substantially rectangular in cross-section.

The output fibre is preferably circular or substantially circular in cross-section.

An outer capillary may be arranged circumferentially around at least the distal end of a stack or bundle of fibres, and/or around at least the distal end of all the fibres.

According to the present invention in a further aspect there is provided a method of forming an optical combiner, comprising a plurality of input optical fibres which have a non-circular cross-section, the fibres having a proximal end for receiving light from a respective diode emitter and a distal end, the fibres being combined at their distal ends and joined to a single output fibre, whereby in use light from a plurality of diode emitters is combined and output through the single output fibre.

Preferably, the input fibres are rectangular or substantially rectangular in cross-section.

The output fibre is preferably circular or substantially circular in cross-section.

A capillary may be mounted around at least the portion of the fibres which are fused to form the combiner. Alternatively, and/or additionally, a capillary may be mounted around each stack or bundle of fibres.

Embodiments of the invention will now be described, by way of example only, with reference to the accompanying schematic drawings, in which:

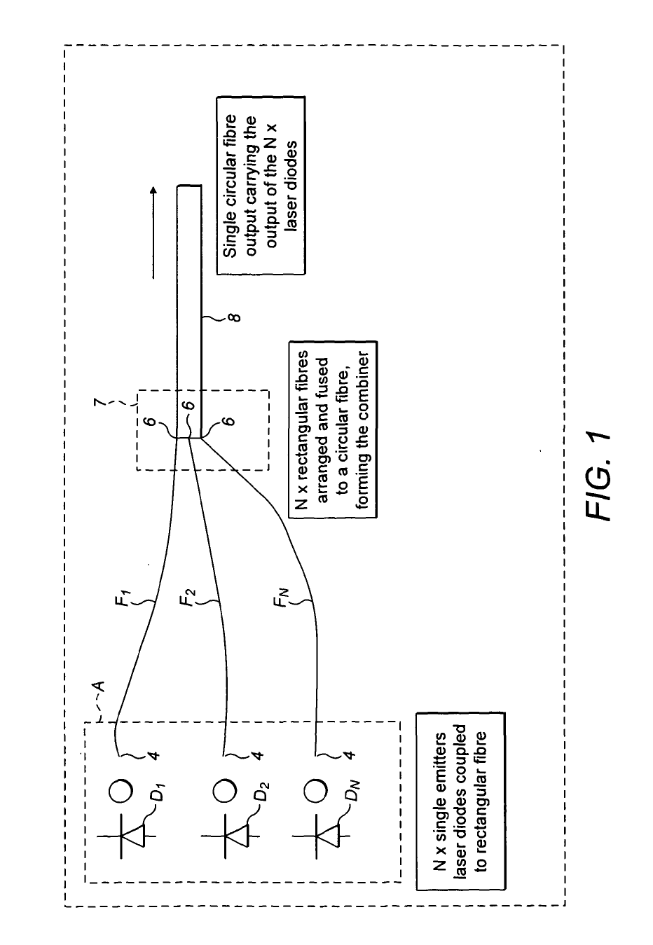

FIG. 1 shows a combiner arrangement;

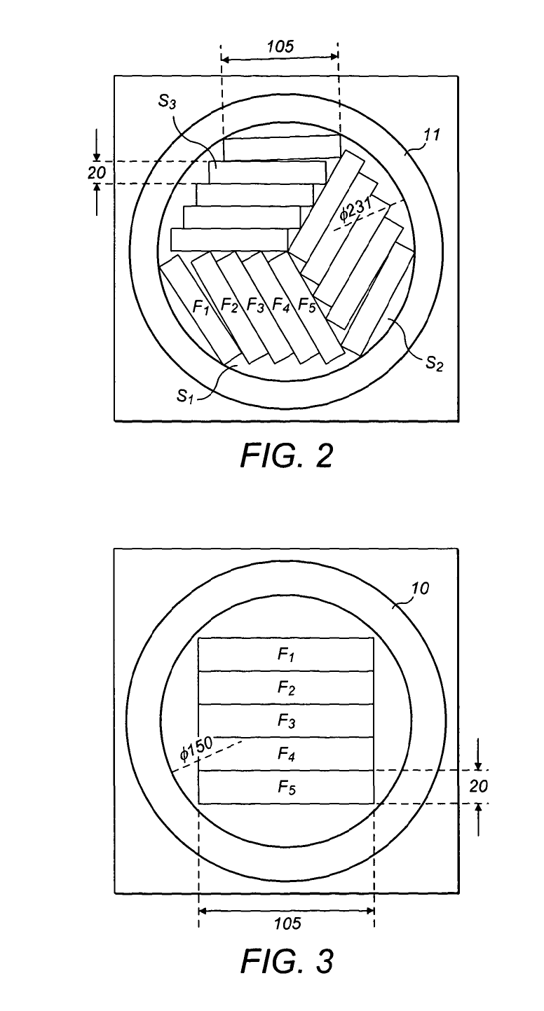

FIG. 2 shows a cross-section through an arrangement of optical fibres;

FIG. 3 shows a cross-section through an arrangement of optical fibres;

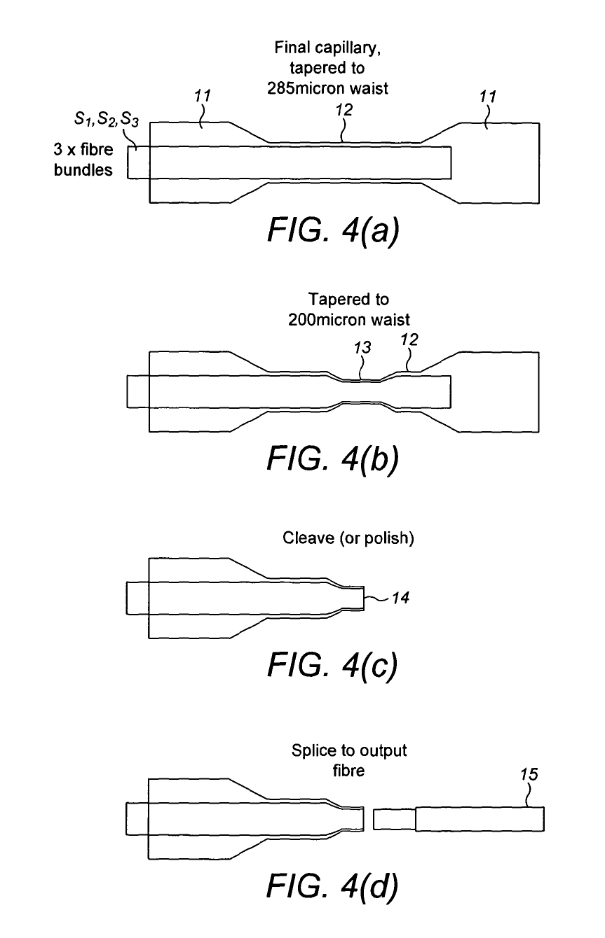

FIGS. 4(a) to 4(d) show manufacturing steps;

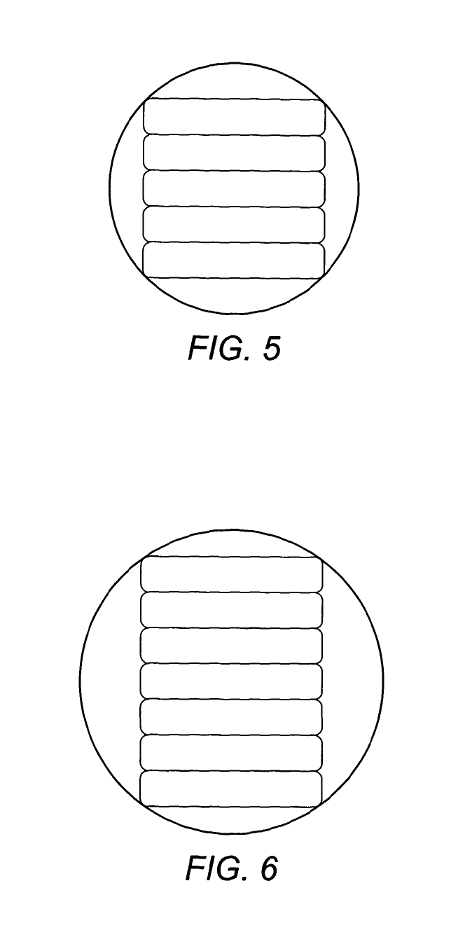

FIG. 5 shows a rectangular 5 by 1 linear stack of fibres;

FIG. 6 shows a stack of 7 fibres;

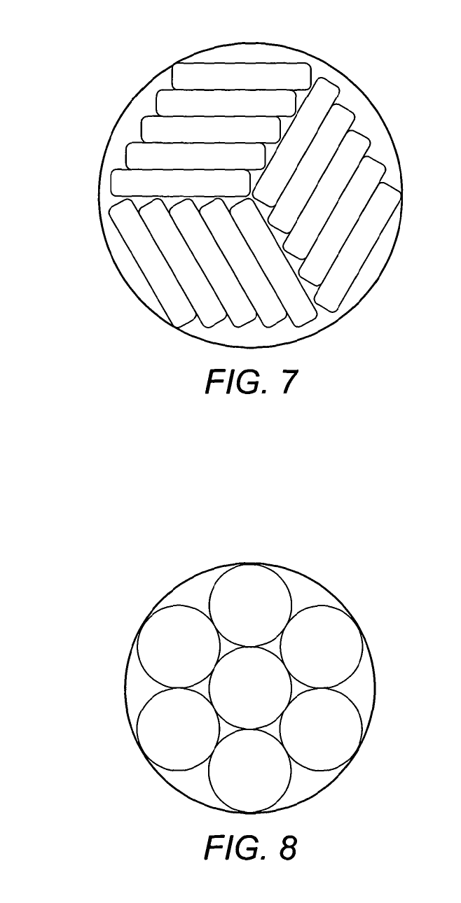

FIG. 7 shows an array of 15 fibres;

FIG. 8 shows an array of 7 circular fibres;

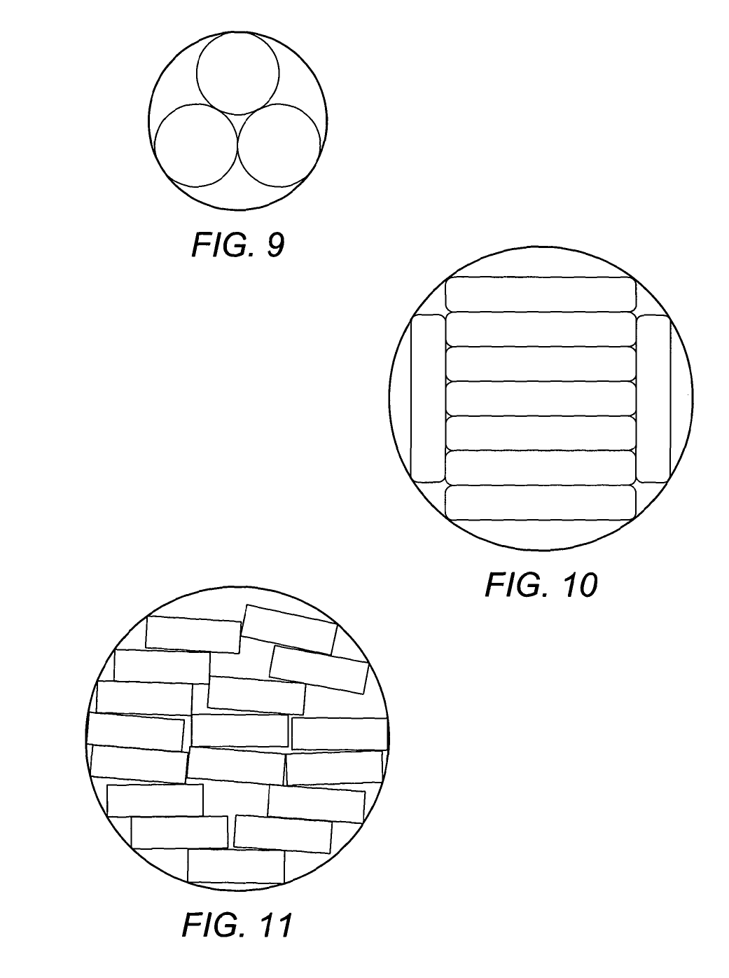

FIG. 9 shows an array of 3 circular fibres;

FIG. 10 shows an array of 9 rectangular fibres; and

FIG. 11 shows an arrangement in which input fibres are not arranged in stacks.

Referring to FIG. 1, a general arrangement is shown. An array A of single emitter laser diodes D1, D2 . . . Dn are arranged to emit laser outputs to an array of N rectangular or other generally elongate cross section fibres F1, F2 . . . Fn, each diode emitting into a respective one of the fibres F1, F2 . . . Fn. Note that in certain embodiments there may be only two such fibres or any number more than two. The outputs from the lasers are emitted into free proximal ends 4 of fibres. At their respective distal ends 6, the fibre F1, F2 . . . Fn are fused together to a circular fibre 8, which then carries the combined laser or other light energy from the diode.

A combiner 7 is thus formed where the input fibres are fused and joined to the output fibre.

The single circular fibre 8 provides an output carrying the combined output of the N times laser diodes. This may be used on its own or for pumping a fibre laser or for many other purposes.

The cross-section of the input fibres F1 to Fn and their aspect ratio is designed to better match the geometry of a diode facet than previous circular designs. It is most preferably rectangular or substantially rectangular. They may have curved ends or corners for example but will still be substantially rectangular. A fibre with rectangular or other elongate cross-sections reduces the loss of brightness at the fibre coupling stage. It is believed that the factor by which brightness is maintained may be five to ten times more than with circular fibres, although it may be more or less than this range.

The process of combining the output from two or more input fibres into a single output fibre usually leads to a decrease in the brightness of the light, due to the combined cross-sectional area of the cores of the input fibres being less than or equal to the cross-sectional area of the core of the output fibre. In other words, the fill-factor of the combiner (equal to the ratio of the input to output core cross-sectional areas) has a value less than or equal to unity. The equation below describes this for a combiner with i individual input fibres, where Aᵢ is the core cross-sectional area of the individual fibres and B is the core cross-sectional area of the output fibre:

$$η = \frac{{\sum }_{i} {A}_{i}}{B} \leq 1$$

The value of this fill-factor will vary for different combiner geometries.

The table below shows the theoretical brightness for a 10 W laser diode coupled into both circular and rectangular fibres (Diode power=10 W; emitter width=100 μm; Divergence=9° (slow axis); M2=1.1 (fast-axis), λ=915 nm; assume 100% transmission through fibre). The brightness of the diode without coupling fibre is approximately 50 MW/cm².sr.

| Fibre Geometry | Brightness (MW/cm²/sr) |
|---|---|
| Circular, 105 micron core | 1.6 |
| diameter, 0.15NA core NA | |
| Rectangular, 105 × 20 | 6.7 |
| micron core dimensions, | |
| 0.15 core NA | |

For these particular fibres, the rectangular fibre output has approximately 4.2 times the brightness of the circular fibre.

The following table shows examples of the brightness that can be obtained with different combiner configurations, for both of the fibre types described above.

| | | | | Input | Output |
|---|---|---|---|---|---|
| | | No. of | Fill- | Brightness | Brightness |
| Example # | Fibre type | fibres | factor | (MW/cm²/sr) | (MW/cm²/sr) |
| 1 | Circular | 3 | 0.64 | 1.6 | 1.0 |
| 2 | Circular | 7 | 0.78 | 1.6 | 1.25 |
| 3 | Rectangular | 5 | 0.63 | 6.7 | 4.2 |
| 4 | Rectangular | 7 | 0.61 | 6.7 | 4.1 |
| 5 | Rectangular | 9 | 0.73 | 6.7 | 4.9 |
| 6 | Rectangular | 15 | 0.78 | 6.7 | 5.2 |

For each combiner, the change in brightness from the input to output stage is directly dependent on the fill-factor for that particular combiner configuration. FIG. 9 shows example 1, FIG. 8 shows example 2, FIG. 5 shows example 3, FIG. 6 shows example 4, FIG. 10 shows example 5 and FIG. 7 shows example 6.

For combiners comprised of circular cross-section fibres, the close-packed hexagonal geometry (e.g. Example #2 in the table above) is particularly attractive, since it has both a relatively high fill-factor and is also straightforward to achieve in practise.

By contrast, the most readily produced arrangement for rectangular cross-section fibres is a linear stack (such as that of FIG. 3, 5 or 6). For such a linear stack, the optimum fill factor is obtained when the stack forms a square cross-section (i.e. N_fibres×fibre height=fibre width). In this case, the fill-factor=0.64. For fibres where a completely square stack cannot be achieved, the fill-factor will be less than 0.64 (e.g. Examples #3 and #4 in the table above). Similarly, input fibres with a cladding present will also have a fill-factor less than 0.64.

The present invention seeks to better preserve the input brightness of a rectangular-fibre combiner by presenting alternative geometries that have an improved fill-factor when compared to the fill-factor of a linear stack of rectangular fibres i.e. geometries with a fill-factor exceeding 0.64.

One such example is the 9:1 combiner shown in FIG. 6 where 7 fibres are arranged in a linear stack and two additional fibres have been rotated by 90 degrees and placed on the sides of this stack. Such an arrangement has an optimal fill-factor of 0.76 (where fibre width=5×fibre height). For the rectangular fibres described above, the fill-factor is reduced to 0.73 and so the output brightness is 4.9 MW/cm²/sr. This represents an improvement of nearly 16% over a linear-stack combiner geometry comprised of 5 of these rectangular fibres.

A further example is the 15:1 combiner shown in FIG. 7. A bundle of 5 fibres is arranged in an angled-stack; 3 such stacks are then arranged as shown. This example has a fill-factor equal to 0.78 for the rectangular fibres described above with an output brightness of 4.9 MW/cm²/sr. This represents an improvement of nearly 24% over a linear-stack combiner geometry comprised of 5 of these rectangular fibres.

In each case, an outer capillary 11 is provided to provide a convenient and innovative way of retaining the fibres prior to fusion.

It should be noted that there are numerous other arrangements that will give fill-factors exceeding 0.64. For example, there may be more or less than three stacks, e.g. one, two, four, five or more. Thus, a multi-fold arrangement may be formed.

It is not essential that the non-circular fibres are arranged in a highly-organised manner in order to produce an enhanced fill-factor. They may be allowed to take up any arbitrary arrangement with each other.

For large numbers of non-circular fibres, it may be found that the fibres ‘self-organise’ into a close-packed geometry. In this case the fibres are not arranged in well-defined stacks and do not display any form of symmetry.

An example is the 17:1 combiner shown in FIG. 11. This example shows non-circular fibres with dimensions 100×33 μm arranged within an outer capillary. In this example, the fill-factor equals 0.70 and so still exceeds that of a regular square stack of fibres. Many other configurations will be apparent.

As described, the bundles of fibres in the chosen configuration are fused at their distal end and combined with a single output fibre such that signals passing via each of the fibres is output through the single output fibre.

The use of an outer capillary as a fixturing tool to bundle together a number of rectangular fibres allows a combiner to be more readily assembled and also reduces the risk of damage and/or contamination.

Where a plurality of stacks are provided they need not necessarily all have the same number of fibres, configurations of fibres or fibre dimensions.

Indeed, the dimensions of fibres within a single stack or bundle need not necessarily be the same, although this will be usual situation.

FIG. 4 shows schematically how a combiner can be manufactured. Initially, a bundle of fibres which may have 105×20 μm cores and 125×40 μm cladding are provided. In the example shown in FIG. 4, three bundles are provided and these may be in 3×5 arrangement as in FIG. 2, 3×7, 3×9 or any other configuration. Each of the fibres is initially provided separately. In a first step, each of the fibres is etched, typically in a HF (hydrofluoric) acid, to remove most of the cladding layer.

In a second step, a bundle of five fibres, arranged in a linear stack, with the etched ends protruding, is loaded into a short section of capillary which, for this size of fibre, may be of 282 μm inner diameter.

In a third step, the five fibres in the stack are fixed into the capillary of any convenient method such as using adhesive or light fusion. The capillary is attached to the unetched portion of the fibres. A typical stack at this stage will have an appearance as shown schematically in FIG. 3.

In a fourth step, a relatively long section of a larger-bore capillary (OD in range 1.0-1.5 mm) which may typically be of about 100 mm in length is prepared with two tapered portions applied somewhere between its two ends, typically in the middle. The first of these may have an inner diameter of the tapered section of 615 μm and the second of these tapered sections (which preferably lies within the first) may have an inner diameter of 230 μm. The first tapered section is intended to accommodate the 3 capillary sections produced in the third step. The second tapered portion is intended to accommodate the etched fibres that protrude from these separate stacks.

In a fifth step, three of the stacks form in step 3 are loaded into the long section of capillary prepared in step 4 (to produce a configuration generally as shown in FIG. 2). It should be noted, as described above, that although the fibres in each stack will initially form a linear stack (as per FIG. 3), the fibres will assume the angled (offset) geometry shown in FIG. 2 (where respective fibres in a stack are offset one from each other) due to being guided by the inner wall of the tapered section of the capillary 11.

This is shown in FIG. 4a where the fibre bundle S1, S2, S3 are loaded into the capillary 11 which has a tapered portion 12 in the middle.

In a sixth step, the bundle of fibres and capillary is fused and tapered at a waist 13 within the tapered part 12 to provide a waist of a desired diameter, such as 187 μm. Methods of fusing and tapering are in themselves well known. This is shown at FIG. 4(b).

In a seventh step, shown in FIG. 4(c) the fused bundle is cleaved at a cleave point 14 at the waist.

Finally, in an eighth step, the cleaved assembly is spliced to a desired output fibre 15 [which will generally be a circular core fibre]. In this example, the core diameter could be 150 μm and the cladding diameter 165 μm, with a core NA value equal to 0.22.

Other methods of manufacture will be apparent.

For optimum brightness preservation, an arrangement such as that shown in FIG. 7 is advantageous due to the exceptional fill-factor that can be achieved. This and other arrangements of fibres in discrete stacks allows for tight-packing as shown. However, an arrangement such as shown in FIG. 11 has the advantage of requiring less skill to produce and still offers an improvement in fill-factor over the single stack arrangements shown in, for example, FIG. 3, 5 or 6.

1. An optical assembly comprising a combiner having a plurality of inputs comprising optical fibres which have a non-circular core cross-section, the fibres having a proximal end for receiving light from a respective diode emitter and a distal end, the fibres being combined at their distal ends and joined to a single output fibre which has a circular core cross-section, whereby in use light from a plurality of diode emitters is combined and output through the single output fibre.

2. An optical assembly as recited in claim 1, wherein the fill-factor for the combiner exceeds 0.64.

3. An optical assembly as recited in claim 1, wherein the non-circular fibres are in an arbitrary arrangement.

4. An optical assembly as recited in claim 1, wherein the input fibres are arranged in one or more stacks or bundles.

5. Apparatus as recited in claim 1, wherein the fibres are rectangular or substantially rectangular in cross-section.

6. An assembly as recited in claim 1, wherein an outer capillary is arranged around the fibres.

7. An assembly as recited in claim 1, wherein an outer capillary is arranged around each stack or bundle of fibres.

8. An assembly as recited in claim 1, comprising a multi-fold stack of fibres.

9. An assembly as recited in claim 8, comprising three stacks of five fibres arranged in a three-fold configuration at the combining portion.

10. An assembly as recited in claim 1, comprising one or more stacks having seven fibres in a stack.

11. A method of forming an optical combiner comprising a plurality of inputs comprising optical fibres which have a non-circular core cross-section, the fibres having a proximal end for receiving light from a respective diode emitter and a distal end, the fibres being combined at their distal ends and joined to a single output fibre which has a circular core cross-section, whereby in use light from a plurality of diode emitters is combined and output through the single output fibre.

12. A method as recited in claim 11, wherein the fill-factor for the combiner exceeds 0.64.

13. A method as recited in claim 11, wherein the input fibres are rectangular or substantially rectangular in cross-section.

14. A method as recited in claim 11, wherein the fibres are formed from one or more stacks.

15. A method as recited in claim 11, wherein the fibres are arranged in stacks of five and/or stacks of seven.

16. A method as recited in claim 11, wherein a plurality of stacks are provided having rotational symmetry.

17. A method as recited in claim 11, comprising a capillary mounted around at least a portion of the fibres which are fused to form the combiner.

18. A method as recited in claim 11, wherein a capillary is mounted around each stack or bundle of fibres.

19-21. (canceled)
